(19) United States
(12) Patent Application Publication
(10) Pub. No.: US 2016/0144344 A1
(43) Pub. Date: May 26, 2016

(54) EXHAUST GAS PURIFYING CATALYST

(71) Applicant: Mitsui Mining & Smelting Co., Ltd., Tokyo (JP)

(72) Inventors: Takahiro SATO, Saitama (JP); Yunosuke NAKAHARA, Saitama (JP); Masato MACHIDA, Kumamoto (JP)

(21) Appl. No.: 15/012,289

(22) Filed: Feb. 1, 2016

Related U.S. Application Data
(62) Division of application No. 13/808,993, filed on Jan. 8, 2013.

(30) Foreign Application Priority Data
Jul. 9, 2010 (JP) 2010-157146

(51) Int. Cl. B01J 23/63; B01J 23/10; B01J 23/58; B01J 35/00

(52) U.S. Cl. CPC B01J 23/63; B01J 35/0006; B01J 23/10; B01J 23/58

(57) ABSTRACT

Disclosed is a carrier for an exhaust gas purifying catalyst, the carrier containing aluminum borate represented by 9Al₂O₃ 2B₂O₃ and modified with La₂O₃ in an amount of 0.3 to 2 mass % on the basis of the mass of the aluminum borate; an exhaust gas purifying catalyst containing the carrier, and Pd or Pd+Ba supported on the carrier; an exhaust gas purifying catalyst product containing a catalyst support made of a ceramic or metallic material, and a layer of the exhaust gas purifying catalyst supported on the catalyst support, which catalyst product may also contain an Rh catalyst layer supported on the layer of the exhaust gas purifying catalyst; and a method for producing the exhaust gas purifying catalyst.

### TECHNICAL FIELD

The present invention relates to an exhaust gas purifying catalyst, and to a method for producing the catalyst. More particularly, the present invention relates to an exhaust gas purifying catalyst which exhibits excellent exhaust gas purifying performance even after long-term use thereof under high-temperature conditions, which exhibits a high degree of dispersion of a noble metal (in particular, Pd), and which removes toxic components contained in exhaust gas discharged from an internal combustion engine of, for example, an automobile; and to a method for producing the catalyst.

### BACKGROUND ART

Exhaust gas discharged from an internal combustion engine of, for example, an automobile contains toxic components such as hydrocarbons (HC), carbon monoxide (CO), and nitrogen oxides (NOₓ). Hitherto, three-way catalysts have been used for removing such toxic components for detoxifying the exhaust gas.

Such a three-way catalyst includes as a noble metal (e.g., Pt, Pd, or Rh) serving as a catalytically active component; a material such as alumina, ceria, zirconia, or oxygen storing capacity ceria-zirconia composite oxide, serving as a carrier; and a catalyst support made of a ceramic or metallic material and having a shape of honeycomb, plate, pellet, etc. Recently, the regulation of automobile exhaust gas has been more strict, and the prices of Pt and Rh, which are noble metals serving as a main catalytically active component of internal combustion engine, exhaust gas purifying catalysts, have risen. Under such circumstances, efforts have been made on reduction of exhaust gas purifying catalyst production cost by use of relatively cheap Pd as a catalytically active component, and various means therefor have been proposed (see, for example, Patent Documents 1, 2, and 3). Also, there has been proposed a catalyst containing aluminum borate as a carrier; specifically, a catalyst which exhibits improved gas diffusibility and is produced by causing a catalyst component to be supported on a powder compact containing a powdery material having hollow portions therein and covered with aluminum borate whiskers (see Patent Document 4).

### PRIOR ART DOCUMENT

### Patent Document

Patent Document 1: Japanese Patent Application Laid-Open (kokai) No. H06-099069
Patent Document 2: Japanese Patent Application Laid-Open (kokai) No. H07-171392
Patent Document 3: Japanese Patent Application Laid-Open (kokai) No. H08-281071
Patent Document 4: Japanese Patent Application Laid-Open (kokai) No. 2002-370035

### SUMMARY OF THE INVENTION

### Problems to be Solved by the Invention

However, since aluminum borate whiskers have an acicular shape and thus have a small specific surface area, the catalyst employing the whiskers inevitably involves aggregation of noble metal particles after having been subjected to high-temperature conditions; i.e., the catalyst poses a problem in terms of durability.

An object of the present invention is to provide an exhaust gas purifying catalyst which exhibits excellent exhaust gas purifying performance even after long-term use thereof under high-temperature conditions, and which exhibits a high degree of dispersion of a noble metal (in particular, Pd). Another object of the present invention is to provide a method for producing the catalyst.

### Means for Solving the Problems

In order to achieve the aforementioned objects, the present inventors have conducted extensive studies, and as a result have found that when Pd is supported on a carrier formed of highly thermally resistant aluminum borate represented by 9Al₂O₃.2B₂O₃ and modified with La₂O₃, the resultant catalyst exhibits excellent exhaust gas purifying performance even after long-term use thereof under high-temperature conditions, and exhibits a high Pd dispersion degree, as compared with a catalyst produced by causing Pd to be supported on a carrier formed of La-stabilized alumina. The present invention has been accomplished on the basis of this finding.

Accordingly, the present invention provides a carrier for an exhaust gas purifying catalyst, characterized in that the carrier comprises aluminum borate represented by 9Al₂O₃.2B₂O₃ and modified with La₂O₃ in an amount of 0.3 to 2 mass % on the basis of the mass of the aluminum borate.

The present invention also provides an exhaust gas purifying catalyst, characterized in that the catalyst comprises a carrier containing aluminum borate represented by 9Al₂O₃.2B₂O₃ and modified with La₂O₃ in an amount of 0.3 to 2 mass % on the basis of the mass of the aluminum borate; and Pd supported on the carrier.

The present invention also provides an exhaust gas purifying catalyst, characterized in that the catalyst comprises a carrier containing aluminum borate represented by 9Al₂O₃.2B₂O₃ and modified with La₂O₃ in an amount of 0.3 to 2 mass % on the basis of the mass of the aluminum borate; and Pd and Ba supported on the carrier.

The present invention also provides an exhaust gas purifying catalyst product, characterized in that the catalyst product comprises a catalyst support made of a ceramic or metallic material, and a layer which is formed of the aforementioned exhaust gas purifying catalyst of the present invention and which is supported on the catalyst support.

The present invention also provides an exhaust gas purifying catalyst product, characterized in that the catalyst product comprises a catalyst support made of a ceramic or metallic material; a layer of the aforementioned exhaust gas purifying catalyst supported on the catalyst support; and a rhodium catalyst layer supported on the layer of the exhaust gas purifying catalyst.

The present invention also provides a method for producing an exhaust gas purifying catalyst, characterized in that the method comprises mixing aluminum borate represented by 9Al₂O₃.2B₂O₃ with a solution of a lanthanum compound; evaporating the mixture to dryness and firing the mixture, to thereby produce aluminum borate which is represented by 9Al₂O₃.2B₂O₃ and which is modified with La₂O₃; mixing the La₂O₃-modified aluminum borate with a solution of a Pd compound or with a solution of a Ba compound and a Pd compound; and evaporating the mixture to dryness and firing the mixture.

### Effects of the Invention

The carrier for an exhaust gas purifying catalyst of the present invention is useful for producing an exhaust gas purifying catalyst which exhibits excellent exhaust gas purifying performance even after long-term use thereof under high-temperature conditions and which exhibits a high degree of dispersion of a noble metal (in particular, Pd). The exhaust gas purifying catalyst of the present invention and the exhaust gas purifying catalyst product of the present invention exhibit excellent exhaust gas purifying performance even after long-term use thereof under high-temperature conditions, and have a high Pd dispersion degree. The production method of the present invention is suitable for producing the exhaust gas purifying catalyst of the present invention.

### MODES FOR CARRYING OUT THE INVENTION

Characteristics of aluminum borate represented by 9Al₂O₃.2B₂O₃ and employed in the present invention, as well as a production method therefor, are described in, for example, Siba P. Ray, “Preparation and Characterization of Aluminum Borate,” J. Am. Ceram. Soc., 75[9], p 2605-2609 (1992). As has been known, aluminum borate represented by 9Al₂O₃.2B₂O₃ has, in its crystal structure, voids having a diameter of about 0.4 nm. The carrier for an exhaust gas purifying catalyst of the present invention is produced by modifying such aluminum borate with La₂O₃ in an amount of 0.3 to 2 mass %, preferably 0.4 to 2 mass %, more preferably 0.5 to 1.5 mass %, on the basis of the mass of the aluminum borate. When the amount of La₂O₃ is less than 0.3 mass % or more than 2 mass % on the basis of the mass of the aluminum borate, as is clear from the Examples and Comparative Examples described hereinbelow, the exhaust gas purifying performance of the catalyst after use thereof under high-temperature conditions may fail to be sufficiently improved.

The carrier for an exhaust gas purifying catalyst of the present invention may be formed of only the aforementioned La₂O₃-modified aluminum borate, or may be formed of a mixture of the aforementioned La₂O₃-modified aluminum borate and a binder which is commonly employed in a three-way catalyst (e.g., alumina) or a carrier such as CeO₂—ZrO₂ having oxygen storing capacity (OSC). That is, the carrier for an exhaust gas purifying catalyst of the present invention contains the aforementioned La₂O₃-modified aluminum borate.

When any of the following noble metals (Pd, Rh, and Pt) is supported on the carrier for an exhaust gas purifying catalyst of the present invention, percent deterioration of the noble metal dispersion degree of the resultant catalyst is suppressed even after long-term use thereof under high-temperature conditions, and noble metal sintering is suppressed after use thereof under high-temperature conditions. When the noble metal is Pd, pronounced effects are obtained.

The exhaust gas purifying catalyst of the present invention includes the carrier containing the aforementioned La₂O₃-modified aluminum borate, and Pd supported on the carrier. The amount of supported Pd, as reduced to metallic Pd, is preferably 0.3 to 3 mass %, more preferably 0.4 to 2 mass %, on the basis of the mass of the carrier. When Pd is supported on the aforementioned La₂O₃-modified aluminum borate, percent deterioration of the Pd dispersion degree of the catalyst is suppressed even after long-term use thereof under high-temperature conditions, and Pd sintering is suppressed after use thereof under high-temperature conditions, as compared with the case where Pd is supported on CeO₂—ZrO₂ having oxygen storing capacity, or Pd is supported on La-stabilized alumina.

Also, the exhaust gas purifying catalyst of the present invention includes the carrier containing the aforementioned La₂O₃-modified aluminum borate, and Pd and Ba supported on the carrier. Since Pd and Ba are supported on the carrier, the oxygen dissociation temperature of PdO can be elevated, and the catalytic action of Pd can be enhanced. The amount of supported Pd and the effects thereof are as described above. The amount of supported Ba, as reduced to BaO, is preferably 2 to 3 mass %, more preferably 2 to 2.5 mass %, on the basis of the mass of metallic Pd.

The exhaust gas purifying catalyst product of the present invention includes a catalyst support made of a ceramic or metallic material, and a layer which is formed of the exhaust gas purifying catalyst of the present invention and which is supported on the catalyst support. The amount of the exhaust gas purifying catalyst supported is preferably 70 to 300 g/L, more preferably 100 to 230 g/L. In the exhaust gas purifying catalyst product, no particular limitation is imposed on the shape of the catalyst support made of a ceramic or metallic material, and the support is generally in the form of honeycomb, plate, pellet, etc., preferably in the form of honeycomb. Examples of the material of the catalyst support include ceramic materials such as alumina (Al₂O₃), mullite (3Al₂O₃-2SiO₂), and cordierite (2MgO—2Al₂O₃-5SiO₂); and metallic materials such as stainless steel.

According to another embodiment of the present invention, the exhaust gas purifying catalyst product includes a layer which is formed of the aforementioned exhaust gas purifying catalyst of the present invention and which is supported on a catalyst support made of a ceramic or metallic material, and an Rh catalyst layer supported on the exhaust gas purifying catalyst layer. In this exhaust gas purifying catalyst product, the shape and material of the ceramic or metallic catalyst support are the same as described above. In the Rh catalyst layer, the amount of supported Rh is preferably 0.1 to 0.6 mass %, more preferably 0.1 to 0.4 mass %, on the basis of the mass of the carrier contained in the Rh catalyst layer. In the exhaust gas purifying catalyst product according to this embodiment, the ratio Pd:Rh is preferably 3 to 20:1, more preferably 5 to 20:1. The amount of the supported lower layer is preferably 70 to 200 g/L, more preferably 100 to 160 g/L. The amount of the supported upper layer is preferably 30 to 100 g/L, more preferably 50 to 70 g/L, from the viewpoints of, for example, thermal resistance, gas diffusion to the lower layer, and exhaust pressure.

The exhaust gas purifying catalyst production method of the present invention includes mixing aluminum borate represented by 9Al₂O₃.2B₂O₃ with a solution of a lanthanum compound; evaporating the mixture to dryness and firing the mixture, to thereby produce aluminum borate which is modified with La₂O₃ and which is represented by 9Al₂O₃.2B₂O₃; mixing the La₂O₃-modified aluminum borate with a solution of a Pd compound or with a solution of a Ba compound and a Pd compound; and evaporating the mixture to dryness and firing the mixture. Steps of the production method will next be described in detail. No particular limitation is imposed on the solvent forming “solution” as described in the present specification, claims, etc., so long as it can form a solution. Generally, water is employed as a solvent.

Aluminum borate represented by 9Al₂O₃.2B₂O₃ and employed in the exhaust gas purifying catalyst production method of the present invention may be commercially available, or may be produced on a laboratory scale through, for example, the following method. Specifically, a solvent (e.g., 2-propanol, butanol, or ethanol) (1.5 L), an Al alkoxide (e.g., aluminum ethoxide, aluminum isopropoxide, aluminum triisopropoxide, aluminum n-butoxide, aluminum s-butoxide, aluminum t-butoxide, aluminum tributoxide, aluminum phenoxide, or aluminum ethoxyethoxyethoxide) which has been ground with an agate mortar (200 g), and a B alkoxide (e.g., boron n-propoxide, boron trimethylsiloxide, boron ethoxyethoxide, boron vinyldimethylsiloxide, boron allyloxide, boron n-butoxide, boron t-butoxide, boron ethoxide, boron isopropoxide, or boron methoxide) (40.9 g) are added to a three-neck flask immersed in a hot water bath at 50° C., and the mixture is stirred under a flow of N₂ gas. When aluminum isopropoxide is employed as the Al alkoxide, 2-propanol is most preferably employed as a solvent, from a production viewpoint, since 2-propanol is generated through hydrolysis of aluminum isopropoxide. After complete dissolution of the Al alkoxide, a mixture of a solvent (e.g., 2-propanol) and water (1:1) (24.6 g) is slowly added dropwise to the flask for gradual hydrolysis, to thereby produce a white gel-like substance. The resultant precipitate is washed with ethanol and then with pure water, and filtration is carried out, followed by drying at 120° C. overnight (for about 15 hours). Thereafter, the resultant product is fired in air at 300° C. for three hours, and then further fired in air at 1,000° C. for five hours, to thereby produce aluminum borate as a white product. The thus-produced aluminum borate can be identified as aluminum borate represented by 9Al₂O₃.2B₂O₃ through X-ray diffractometry.

In the exhaust gas purifying catalyst production method of the present invention, the step of mixing aluminum borate represented by 9Al₂O₃.2B₂O₃ with a solution of a lanthanum compound (a soluble lanthanum compound such as lanthanum nitrate, lanthanum acetate, lanthanum chloride, lanthanum bromide, or lanthanum sulfate) may be replaced with a step of mixing a slurry containing aluminum borate with a solution of a lanthanum compound, or a step of adding aluminum borate to a solution of a lanthanum compound. In this case, the ratio by amount of aluminum borate to a lanthanum compound is adjusted so that the amount of La₂O₃ is 0.3 to 2 mass %, preferably 0.4 to 2 mass %, more preferably 0.5 to 1.5 mass %, on the basis of the mass of the aluminum borate after firing.

Thereafter, the above-prepared mixture is evaporated to dryness at 120° C. overnight (for about 15 hours) so that the lanthanum compound is almost uniformly deposited on the surface of the aluminum borate, followed by firing in air at 600° C. for three hours, to thereby produce aluminum borate which is represented by 9Al₂O₃.2B₂O₃ and which is modified with La₂O₃; i.e., the carrier for an exhaust gas purifying catalyst of the present invention.

Subsequently, the above-produced aluminum borate represented by 9Al₂O₃.2B₂O₃ and modified with La₂O₃ is mixed with a solution of a Pd compound (a soluble Pd compound such as Pd nitrate, Pd chloride, or Pd sulfate). This mixing may be carried out in the presence of a common carrier which is generally employed in three-way catalysts, or a carrier such as CeO₂—ZrO₂ having oxygen storing capacity (OSC). In this case, the ratio by amount of the carrier to the Pd compound is adjusted so that the amount of supported Pd is preferably 0.5 to 3 mass %, more preferably 0.7 to 2 mass %, on the basis of the mass of the entire carrier after firing.

For production of a Pd—Ba-supported exhaust gas purifying catalyst, the above-produced aluminum borate represented by 9Al₂O₃.2B₂O₃ and modified with La₂O₃ is mixed with a solution of a Ba compound (e.g., barium oxide, barium nitrate, barium acetate, barium oxalate, barium hydroxide, or barium carbonate) and a Pd compound (a soluble Pd compound such as Pd nitrate, Pd chloride, or Pd sulfate). This mixing may be carried out in the presence of a common carrier which is generally employed in three-way catalysts, or a carrier such as CeO₂—ZrO₂ having oxygen storing capacity (OSC). In this case, the ratio by amount of the carrier to the Pd compound is adjusted as described above, and the amount of the Ba compound, as reduced to BaO, is adjusted so as to be preferably 2 to 3 mass %, more preferably 2 to 2.5 mass %, on the basis of the mass of metallic Pd.

Thereafter, the above-prepared mixture is evaporated to dryness at 120° C. overnight (for about 15 hours) so that the Pd compound, or both the Pd compound and the Ba compound are almost uniformly deposited on the surface of the carrier, followed by firing in air at 600° C. for three hours, to thereby produce the exhaust gas purifying catalyst of the present invention, the catalyst including aluminum borate represented by 9Al₂O₃.2B₂O₃ and modified with La₂O₃, and Pd or both Pd and Ba supported on the aluminum borate.

The exhaust gas purifying catalyst product of the present invention may be produced through, for example, the following method. Specifically, a Pd compound solution is mixed with aluminum borate represented by 9Al₂O₃.2B₂O₃ and modified with La₂O₃, a binder, and optionally a carrier such as CeO₂—ZrO₂ having oxygen storing capacity, and optionally a Ba compound, and the resultant mixture is subjected to wet grinding, to thereby prepare a slurry. The thus-prepared slurry is applied onto a catalyst support made of a ceramic or metallic material through a widely known method. The catalyst support is preferably a honeycomb-shape catalyst support. Thereafter, drying and firing is carried out, to thereby produce the exhaust gas purifying catalyst product including the catalyst support, and a layer of the exhaust gas purifying catalyst supported on the catalyst support. Also, the exhaust gas purifying catalyst product including the exhaust gas purifying catalyst layer and an Rh catalyst layer supported thereon can be produced in a manner similar to that described above.

The present invention will next be described in detail by way of Examples and Comparative Examples.

### EXAMPLE 1

2-Propanol (1.5 L), aluminum isopropoxide which had been ground with an agate mortar (200 g), and boron n-propoxide (40.9 g) were added to a three-neck flask immersed in a hot water bath at 50° C., and the mixture was stirred under a flow of N₂ gas. After aluminum isopropoxide had completely dissolved (i.e., the solution had become transparent), a mixture of 2-propanol and water (1:1) (24.6 g) was slowly added dropwise to the flask for gradual hydrolysis, to thereby produce a white gel-like substance. The resultant precipitate was washed with ethanol and then with pure water, and filtration was carried out, followed by drying at 120° C. overnight (for about 15 hours). Thereafter, the resultant product was fired in air at 300° C. for three hours, and then further fired in air at 1,000° C. for five hours, to thereby produce aluminum borate as a white product. The thus-produced aluminum borate was identified as aluminum borate represented by 9Al₂O₃.2B₂O₃ through X-ray diffractometry.

The above-produced aluminum borate was immersed in an aqueous lanthanum nitrate solution. The amount of lanthanum nitrate contained in the aqueous lanthanum nitrate solution was adjusted so that the La₂O₃ content of aluminum borate represented by 9Al₂O₃.2B₂O₃ and modified with La₂O₃ (i.e., product of interest) was 0.5 mass % on the basis of the mass of the aluminum borate. Thereafter, the resultant mixture was evaporated to dryness at 120° C. overnight (for about 15 hours), and fired in air at 600° C. for three hours, to thereby produce aluminum borate represented by 9Al₂O₃.2B₂O₃ and modified with La₂O₃ (0.5 mass %).

Subsequently, the above-produced aluminum borate represented by 9Al₂O₃.2B₂O₃ and modified with La₂O₃ (0.5 mass %) was immersed in an aqueous Pd nitrate solution. The amount of Pd nitrate (as reduced to metallic Pd) contained in the aqueous Pd nitrate solution was adjusted to 0.4 mass % on the basis of the mass of aluminum borate represented by 9Al₂O₃.2B₂O₃ and modified with La₂O₃ (0.5 mass %). Thereafter, the resultant mixture was evaporated to dryness at 120° C. overnight (for about 15 hours), and fired in air at 600° C. for three hours, to thereby produce the exhaust gas purifying catalyst of the present invention.

### EXAMPLE 2

The procedure of Example 1 was repeated, except that the amount of lanthanum nitrate contained in the aqueous lanthanum nitrate solution was adjusted so that the La₂O₃ content of aluminum borate represented by 9Al₂O₃.2B₂O₃ and modified with La₂O₃ (i.e., product of interest) was 1 mass % on the basis of the mass of the aluminum borate, to thereby produce the exhaust gas purifying catalyst of the present invention.

### EXAMPLE 3

The procedure of Example 1 was repeated, except that the amount of lanthanum nitrate contained in the aqueous lanthanum nitrate solution was adjusted so that the La₂O₃ content of aluminum borate represented by 9Al₂O₃.2B₂O₃ and modified with La₂O₃ (i.e., product of interest) was 2 mass % on the basis of the mass of the aluminum borate, to thereby produce the exhaust gas purifying catalyst of the present invention.

### COMPARATIVE EXAMPLE 1

The procedure of Example 1 was repeated, except that the step of modifying aluminum borate with La₂O₃ was not carried out (i.e., Pd was supported on aluminum borate without modification with La₂O₃), to thereby produce an exhaust gas purifying catalyst for comparison.

### COMPARATIVE EXAMPLE 2

The procedure of Example 1 was repeated, except that the amount of lanthanum nitrate contained in the aqueous lanthanum nitrate solution was adjusted so that the La₂O₃ content of aluminum borate represented by 9Al₂O₃.2B₂O₃ and modified with La₂O₃ (i.e., product of interest) was 3 mass % on the basis of the mass of the aluminum borate, to thereby produce an exhaust gas purifying catalyst for comparison.

### COMPARATIVE EXAMPLE 3

The procedure of Example 1 was repeated, except that the amount of lanthanum nitrate contained in the aqueous lanthanum nitrate solution was adjusted so that the La₂O₃ content of aluminum borate represented by 9Al₂O₃.2B₂O₃ and modified with La₂O₃ (i.e., product of interest) was 5 mass % on the basis of the mass of the aluminum borate, to thereby produce an exhaust gas purifying catalyst for comparison.

### COMPARATIVE EXAMPLE 4

La-stabilized alumina was immersed in an aqueous Pd nitrate solution. The amount of Pd nitrate (as reduced to metallic Pd) contained in the aqueous Pd nitrate solution was adjusted to 0.4 mass % on the basis of the mass of the La-stabilized alumina. Thereafter, the resultant mixture was evaporated to dryness at 120° C. overnight (for about 15 hours), and fired in air at 600° C. for three hours, to thereby produce an exhaust gas purifying catalyst for comparison.

### <Evaluation>

Each of the exhaust gas purifying catalysts produced in Examples 1 to 3 and Comparative Examples 1 to 3 was treated in an air atmosphere containing water vapor (10%) at 900° C. for 25 hours. Thereafter, the catalytic activity of the exhaust gas purifying catalyst was evaluated in the following manner. Specifically, powder of the catalyst was placed in a reaction tube of a fixed-bed flow reaction apparatus, and a simulated exhaust gas; i.e., a gas which simulated a complete combustion gas and which was composed of CO (0.51%), NO (500 ppm), C₃ H₆ (1,170 ppmC), 0₂ (0.4%), and N₂ (balance), was caused to flow through the reaction tube so as to attain a W/F (mass of catalyst/gas flow rate) of 5.0×10⁻⁴ g·min·cm⁻³. The composition of the outlet gas was measured in a temperature range of 100 to 500° C. by means of a CO/HC/NO analyzer. On the basis of the thus-determined light-off performance of the catalyst, the temperature at which 10%, 50%, or 90% of NO was removed (T10, T50, or T90) was determined. The results are shown in Table 1.

TABLE 1

| | Amount of La₂O₃ for | | | |
|---|---|---|---|---|
| | modification | T10 | T50 | T90 |
| Comp. Ex. 1 | 0 mass % | 312° C. | 343° C. | 382° C. |
| Ex. 1 | 0.5 mass % | 255° C. | 300° C. | 340° C. |
| Ex. 2 | 1 mass % | 233° C. | 284° C. | 325° C. |
| Ex. 3 | 2 mass % | 275° C. | 312° C. | 376° C. |
| Comp. Ex. 2 | 3 mass % | 319° C. | 346° C. | 427° C. |
| Comp. Ex. 3 | 5 mass % | 304° C. | 358° C. | 417° C. |

As is clear from the data shown in Table 1, a Pd catalyst including a carrier formed of aluminum borate represented by 9Al₂O₃.2B₂O₃ and modified with a specific amount of La₂O₃ exhibited excellent catalytic activity even after long-term use thereof under high-temperature conditions.

Each of the exhaust gas purifying catalysts produced in Example 2 and Comparative Example 4 was treated in an air atmosphere containing water vapor (10%) at 900° C., 1,000° C., 1,100° C., or 1,200° C. for 25 hours. Thereafter, the catalytic activity of the exhaust gas purifying catalyst was evaluated in the following manner. Specifically, powder of the catalyst was placed in a reaction tube of a fixed-bed flow reaction apparatus, and a simulated exhaust gas; i.e., a gas which was simulated a complete combustion gas and which was composed of CO (0.51%), NO (500 ppm), C₃H₆ (1,170 ppmC), O₂ (0.4%), and N₂ (balance), was caused to flow through the reaction tube so as to attain a W/F (mass of catalyst/gas flow rate) of 5.0×10⁻⁴ g·min·cm⁻³. The composition of the outlet gas was measured in a temperature range of 100 to 500° C. by means of a CO/HC/NO analyzer. On the basis of the thus-determined light-off performance of the catalyst, the temperature at which 50% of NO was removed (T50) was determined. The results are shown in Table 2.

TABLE 2

| Treatment | T50 | |
|---|---|---|
| temperature | Catalyst of Comparative Example 4 | Catalyst of Example 2 |
| 900° C. | 330° C. | 284° C. |
| 1000° C. | 339° C. | 337° C. |
| 1100° C. | 404° C. | 355° C. |
| 1200° C. | 432° C. | 366° C. |

As is clear from the data shown in Table 2, when the catalyst of Comparative Example 4 was treated at a temperature higher than 1,000° C., the NOₓ light-off performance of the catalyst was deteriorated as the treatment temperature increased. In contrast, deterioration of the NO light-off performance of the catalyst of Example 2 was suppressed, as compared with the case of the catalyst of Comparative Example 4. That is, the catalyst of Example 2 exhibited excellent high-temperature durability.

There were prepared a carrier formed of La-stabilized alumina, a carrier formed of non-La₂O₃-modified aluminum borate represented by 9Al₂O₃.2B₂O₃, and a carrier formed of aluminum borate represented by 9Al₂O₃.2B₂O₃ and modified with La₂O₃ (1 mass %). Each of the carriers was treated in an air atmosphere containing water vapor (10%) at 1,000° C. for 25 hours. The BET value of the catalyst was measured before and after the 25-hour treatment. Percent reduction in BET value was calculated from the thus-measured values. The results are shown in Table 3.

TABLE 3

| | La-stabilized | | Modified |
|---|---|---|---|
| | alumina | Aluminum borate | aluminum borate |
| Before treatment | 140 m²/g | 73 m²/g | 70 m²/g |
| After treatment | 93 m²/g | 61 m²/g | 70 m²/g |
| Percent reduction | 33.4% | 16.9% | 0.0% |

As is clear from the data shown in Table 3, in the case of the carrier formed of aluminum borate, percent reduction in BET value (attributed to thermal treatment) was suppressed, as compared with the case of the carrier formed of La-stabilized alumina. This indicates that aluminum borate exhibits thermal resistance superior to that of La-stabilized alumina. Meanwhile, in the case of the carrier formed of aluminum borate modified with La₂O₃ (1 mass %), no difference was observed between the BET value before thermal treatment and that after thermal treatment. This indicates that aluminum borate modified with La₂O₃ exhibits further improved thermal resistance.

There were prepared catalysts from 1 mass % Pd/CeO₂—ZrO₂ composite oxide (OSC material), 1 mass % Pd/La-stabilized alumina, and 1 mass % Pd/aluminum borate modified with La₂O₃ (1 mass %). Each of the catalysts was treated in an air atmosphere containing water vapor (10%) at 1,000° C. for 25 hours. The degree of Pd dispersion of the catalyst was measured before and after the 25-hour treatment according to the CO pulse adsorption method (i.e., known technique) (T. Takeguchi, S. Manabe, R. Kikuchi, K. Eguchi, T. Kanazawa, S. Matsumoto, Applied Catalysis A: 293 (2005) 91.). The degree of Pd dispersion is calculated by the following formula: degree of Pd dispersion=the amount (by mole) of Pd corresponding to the amount of CO adsorbed/the total amount (by mole) of Pd contained in the catalyst of interest. From the data of the degree of Pd dispersion, percent deterioration of the Pd dispersion degree was determined. The results are shown in Table 4.

TABLE 4

| | Pd/OSC | Pd/La-stabilized | Pd/La₂O₃-modified |
|---|---|---|---|
| | material | alumina | aluminum borate |
| Before treatment | 28.5 | 16.8 | 22.8 |
| After treatment | 0.42 | 0.92 | 1.68 |
| Percent deterioration of | 98.5 | 94.5 | 92.6 |
| Pd dispersion | | | |

The degree of noble metal dispersion indirectly represents the degree of probability of contact between the noble metal and exhaust gas. The higher the degree of noble metal dispersion, the higher the contact efficiency between the noble metal and exhaust gas. As is clear from the data shown in Table 4, percent deterioration of the Pd dispersion degree was suppressed in the case of Pd/aluminum borate modified with La₂O₃ (1 mass %). That is, through employment of the highly thermally resistant material, Pd sintering was prevented after long-term use of the catalyst under high-temperature conditions.

### EXAMPLE 4

### Pd Single Layer, Amount of Supported Pd: 1.3 g/L

Aluminum borate represented by 9Al₂O₃.2B₂O₃ and modified with La₂O₃ (1 mass %) (59.8 parts by mass), CeO₂—ZrO₂ composite oxide (29.6 parts by mass), barium nitrate in an amount corresponding to 3.3 parts by mass of barium oxide, and an alumina binder (6.0 parts by mass) were added to an aqueous Pd nitrate solution, and the resultant mixture was subjected to wet grinding, to thereby prepare a Pd-containing slurry. The amount of Pd nitrate (as reduced to metallic Pd) contained in the aqueous Pd nitrate solution was adjusted to 1.3 mass % with respect to solid content. The thus-prepared slurry was applied to a ceramic honeycomb (catalyst support) at a coating amount of 100 g/L, followed by drying and firing, to thereby produce the exhaust gas purifying catalyst product of the present invention.

### COMPARATIVE EXAMPLE 5

### Pd Single Layer, Amount of Supported Pd: 1.3 g/L

CeO₂—ZrO₂ composite oxide (29.6 parts by mass), La-stabilized alumina (59.8 parts by mass), barium nitrate in an amount corresponding to 3.3 parts by mass of barium oxide, and an alumina binder (6.0 parts by mass) were added to an aqueous Pd nitrate solution, and the resultant mixture was subjected to wet grinding, to thereby prepare a Pd-containing slurry. The amount of Pd nitrate (as reduced to metallic Pd) contained in the aqueous Pd nitrate solution was adjusted to 1.3 mass % with respect to solid content. The thus-prepared slurry was applied to a ceramic honeycomb (catalyst support) at a coating amount of 100 g/L, followed by drying and firing, to thereby produce an exhaust gas purifying catalyst product for comparison.

### <Evaluation>

Each of the exhaust gas purifying catalyst products of Example 4 and Comparative Example 5 was placed in an electric furnace maintained at 1,000° C. To the furnace accommodating the catalyst product, a simulated exhaust gas; i.e., a gas which simulated a complete combustion gas and which was composed of C₃H₆ (5,000 ppmC), O₂ (0.75%), and N₂ (balance), and air were alternately and periodically fed for 25 hours (each for 50 seconds). After the treatment with the simulated exhaust gas, the performances of the exhaust gas purifying catalyst products were compared in the following manner. Specifically, the simulated exhaust gas having the same composition was caused to flow over each of the exhaust gas purifying catalyst products of Example 4 and Comparative Example 5 at a total flow rate of 25 L/min and an SV of 100,000 h⁻¹, after completion of the above treatment. The composition of the outlet gas was measured in a temperature range of 100 to 500° C. by means of a CO/HC/NO analyzer (MOTOR EXHAUST GAS ANALYZER MEXA9100, product of Horiba), whereby the light-off performance of each of the exhaust gas purifying catalyst products of Example 4 and Comparative Example 5 was determined. On the basis of the thus-determined light-off performance, the temperature at which 50% of each gas component (CO, HC, or NO) was removed (T50) was determined. The results are shown in Table 5.

TABLE 5

| | T50 | | |
|---|---|---|---|
| | CO | HC | NOₓ |
| Comparative Example 5 | 347° C. | 345° C. | 352° C. |
| Example 4 | 336° C. | 335° C. | 341° C. |

As is clear from the data shown in Table 5, even after treatment with the simulated exhaust gas, the catalyst product formed from aluminum borate represented by 9Al₂O₃.2B₂O₃ and modified with La₂O₃ (1 mass %) exhibited excellent light-off performance for all of CO, HC, and NOₓ, as compared with the case of the catalyst product formed from La-stabilized alumina, which is a conventionally employed carrier component.

### EXAMPLE 5

### Two-Layer Catalyst Including Pd Lower Layer and Rh Upper Layer, Pd/Rh=5/1, Amount of Supported Pd—Rh: 1.0 g/L)

Aluminum borate represented by 9Al₂O₃.2B₂O₃ and modified with La₂O₃ (1 mass %) (45.6 parts by mass), CeO₂—ZrO₂ composite oxide (45.6 parts by mass), barium nitrate in an amount corresponding to 2.0 parts by mass of barium oxide, and an alumina binder (6.0 parts by mass) were added to an aqueous Pd nitrate solution, and the resultant mixture was subjected to wet grinding, to thereby prepare a Pd-containing slurry. The amount of Pd nitrate (as reduced to metallic Pd) contained in the aqueous Pd nitrate solution was adjusted to 0.83 mass % with respect to solid content. The thus-prepared slurry was applied to a ceramic honeycomb (catalyst support) at a coating amount of 100 g/L, followed by drying and firing.

Separately, Nd₂O₃—ZrO₂ composite oxide (70.3 parts by mass), La-stabilized alumina (23.4 parts by mass), and an alumina binder (6.0 parts by mass) were added to an aqueous Rh nitrate solution, and the resultant mixture was subjected to wet grinding, to thereby prepare an Rh-containing slurry. The amount of Rh nitrate (as reduced to metallic Rh) contained in the aqueous Rh nitrate solution was adjusted to 0.33 mass % with respect to solid content after firing. The thus-prepared slurry was applied to the above-produced Pd-supported ceramic honeycomb catalyst support at a coating amount of 50 g/L, followed by drying and firing, to thereby produce the exhaust gas purifying catalyst product of the present invention having a Pd/Rh two-layer structure.

### EXAMPLE 6

### Two-Layer Catalyst Including Pd Lower Layer and Rh Upper Layer, Pd/Rh=10/1, Amount of Supported Pd—Rh: 1.0 g/L

Aluminum borate represented by 9Al₂O₃.2B₂O₃ and modified with La₂O₃ (1 mass %) (45.4 parts by mass), CeO₂—ZrO₂ composite oxide (45.4 parts by mass), barium nitrate in an amount corresponding to 2.2 parts by mass of barium oxide, and an alumina binder (6.0 parts by mass) were added to an aqueous Pd nitrate solution, and the resultant mixture was subjected to wet grinding, to thereby prepare a Pd-containing slurry. The amount of Pd nitrate (as reduced to metallic Pd) contained in the aqueous Pd nitrate solution was adjusted to 0.91 mass % with respect to solid content. The thus-prepared slurry was applied to a ceramic honeycomb (catalyst support) at a coating amount of 100 g/L, followed by drying and firing.

Separately, Nd₂O₃—ZrO₂ composite oxide (70.4 parts by mass), La-stabilized alumina (23.5 parts by mass), and an alumina binder (6.0 parts by mass) were added to an aqueous Rh nitrate solution, and the resultant mixture was subjected to wet grinding, to thereby prepare an Rh-containing slurry. The amount of Rh nitrate (as reduced to metallic Rh) contained in the aqueous Rh nitrate solution was adjusted to 0.18 mass % with respect to solid content after firing. The thus-prepared slurry was applied to the above-produced Pd-supported ceramic honeycomb catalyst support at a coating amount of 50 g/L, followed by drying and firing, to thereby produce the exhaust gas purifying catalyst product of the present invention having a Pd/Rh two-layer structure.

### EXAMPLE 7

### Two-Layer Catalyst including Pd Lower Layer and Rh Upper Layer, Pd/Rh=19/1, Amount of Supported Pd—Rh: 1.0 g/L

Aluminum borate represented by 9Al₂O₃.2B₂O₃ and modified with La₂O₃ (1 mass %) (45.4 parts by mass), CeO₂—ZrO₂ composite oxide (45.4 parts by mass), barium nitrate in an amount corresponding to 2.3 parts by mass of barium oxide, and an alumina binder (6.0 parts by mass) were added to an aqueous Pd nitrate solution, and the resultant mixture was subjected to wet grinding, to thereby prepare a Pd-containing slurry. The amount of Pd nitrate (as reduced to metallic Pd) contained in the aqueous Pd nitrate solution was adjusted to 0.95 mass % with respect to solid content. The thus-prepared slurry was applied to a ceramic honeycomb (catalyst support) at a coating amount of 100 g/L, followed by drying and firing.

Separately, Nd₂O₃—ZrO₂ composite oxide (70.4 parts by mass), La-stabilized alumina (23.5 parts by mass), and an alumina binder (6.0 parts by mass) were added to an aqueous Rh nitrate solution, and the resultant mixture was subjected to wet grinding, to thereby prepare an Rh-containing slurry. The amount of Rh nitrate (as reduced to metallic Rh) contained in the aqueous Rh nitrate solution was adjusted to 0.10 mass % with respect to solid content after firing. The thus-prepared slurry was applied to the above-produced Pd-supported ceramic honeycomb catalyst support at a coating amount of 50 g/L, followed by drying and firing, to thereby produce the exhaust gas purifying catalyst product of the present invention having a Pd/Rh two-layer structure.

### EXAMPLE 8

### Pd Single Layer, Amount of Supported Pd: 1.0 g/L

Aluminum borate represented by 9Al₂O₃.2B₂O₃ and modified with La₂O₃ (1 mass %) (45.3 parts by mass), CeO₂—ZrO₂ composite oxide (45.3 parts by mass), barium nitrate in an amount corresponding to 2.4 parts by mass of barium oxide, and an alumina binder (6.0 parts by mass) were added to an aqueous Pd nitrate solution, and the resultant mixture was subjected to wet grinding, to thereby prepare a Pd-containing slurry. The amount of Pd nitrate (as reduced to metallic Pd) contained in the aqueous Pd nitrate solution was adjusted to 1.00 mass % with respect to solid content. The thus-prepared slurry was applied to a ceramic honeycomb (catalyst support) at a coating amount of 100 g/L, followed by drying and firing, to thereby produce the exhaust gas purifying catalyst product of the present invention.

### COMPARATIVE EXAMPLE 6

### Two-Layer Catalyst Including Pd Lower Layer and Rh Upper Layer, Pd/Rh=5/1, Amount of Supported Pd—Rh: 1.0 g/L

The procedure of Example 5 was repeated, except that aluminum borate represented by 9Al₂O₃.2B₂O₃ and modified with La₂O₃ (1 mass %) was replaced with the same amount of La-stabilized alumina, to thereby produce an exhaust gas purifying catalyst product for comparison.

### COMPARATIVE EXAMPLE 7

### Two-Layer Catalyst Including Pd Lower Layer and Rh Upper Layer, Pd/Rh=10/1, Amount of Supported Pd—Rh: 1.0 g/L

The procedure of Example 6 was repeated, except that aluminum borate represented by 9Al₂O₃.2B₂O₃ and modified with La₂O₃ (1 mass %) was replaced with the same amount of La-stabilized alumina, to thereby produce an exhaust gas purifying catalyst product for comparison.

### COMPARATIVE EXAMPLE 8

### Two-Layer Catalyst Including Pd Lower Layer and Rh Upper Layer, Pd/Rh=19/1, Amount of Supported Pd—Rh: 1.0 g/L

The procedure of Example 7 was repeated, except that aluminum borate represented by 9Al₂O₃.2B₂O₃ and modified with La₂O₃ (1 mass %) was replaced with the same amount of La-stabilized alumina, to thereby produce an exhaust gas purifying catalyst product for comparison.

### COMPARATIVE EXAMPLE 9

### Pd Single Layer, Amount of Supported Pd: 1.0 g/L

The procedure of Example 8 was repeated, except that aluminum borate represented by 9Al₂O₃.2B₂O₃ and modified with La₂O₃ (1 mass %) was replaced with the same amount of La-stabilized alumina, to thereby produce an exhaust gas purifying catalyst product for comparison.

### <Evaluation>

Each of the exhaust gas purifying catalyst products of Examples 5 to 8 and Comparative Examples 6 to 9 was placed in an electric furnace maintained at 1,000° C. To the furnace accommodating the catalyst product, a simulated exhaust gas; i.e., a gas which simulated a complete combustion gas and which was composed of C₃ H₆ (5,000 ppmC), O₂ (0.75%), and N₂ (balance), and air were alternately and periodically fed for 25 hours (each for 50 seconds). After the treatment with the simulated exhaust gas, the performances of the exhaust gas purifying catalyst products were compared in the following manner. Specifically, the simulated exhaust gas having the same composition was caused to flow over each of the exhaust gas purifying catalyst products of Examples 5 to 8 and Comparative Examples 6 to 9 at a total flow rate of 25 L/min and an SV of 100,000 h⁻¹, after completion of the above treatment. The composition of the outlet gas was measured in a temperature range of 100 to 500° C. by means of a CO/HC/NO analyzer (MOTOR EXHAUST GAS ANALYZER MEXA9100, product of Horiba), whereby the light-off performance of each of the exhaust gas purifying catalyst products of Examples 5 to 8 and Comparative Examples 6 to 9 was determined. On the basis of the thus-determined light-off performance, the percent removal of each gas component (CO, HC, or NO) at 400° C. (η400) was determined. The results are shown in Table 6.

TABLE 6

| | Amount of | Amount of | | | |
|---|---|---|---|---|---|
| | supported Pd | supported Rh | η400 (%) | | |
| | (%) | (%) | CO | HC | NOₓ |
| Ex. 8 | 1.00 | 0 | 98.0 | 99.2 | 81.0 |
| Ex. 7 | 0.95 | 0.10 | 97.2 | 98.4 | 96.8 |
| Ex. 6 | 0.91 | 0.18 | 98.2 | 98.7 | 98.1 |
| Ex. 5 | 0.83 | 0.33 | 97.7 | 98.2 | 97.6 |
| Comp. Ex. 9 | 1.00 | 0 | 92.0 | 93.0 | 82.1 |
| Comp. Ex. 8 | 0.95 | 0.10 | 91.4 | 91.8 | 90.7 |
| Comp. Ex. 7 | 0.91 | 0.18 | 92.7 | 93.3 | 91.7 |
| Comp. Ex. 6 | 0.83 | 0.33 | 93.9 | 94.6 | 92.3 |

As is clear from the data shown in Table 6, in the case where a carrier for Pd is formed from La-stabilized alumina (i.e., conventionally employed carrier component) and CeO₂—ZrO₂ composite oxide (Comparative Examples 6 to 9), when the resultant catalyst product is treated with the simulated exhaust gas, the exhaust gas purifying performance of the catalyst product tends to lower as the amount of supported Rh decreases from 0.33% to 0.10%. In contrast, in the case where a carrier for Pd is formed from aluminum borate represented by 9Al₂O₃.2B₂O₃ and modified with La₂O₃ (1 mass %) and CeO₂—ZrO₂ composite oxide, even when the amount of supported Rh decreases from 0.33% to 0.10%, the resultant catalyst product maintains its exhaust gas purifying performance at a level comparable to that attained when the amount of supported Rh is large; i.e., the deterioration of the performance of the catalyst product is suppressed. Thus, employment of aluminum borate represented by 9Al₂O₃.2B₂O₃ and modified with La₂O₃ (i.e., highly thermally resistant material) is expected to considerably reduce the amount of Rh required.

1. An exhaust gas purifying catalyst product, comprising:
a catalyst support made of a ceramic or metallic material; and
a layer which is formed of an exhaust gas purifying catalyst and which is supported on the catalyst support,
wherein the exhaust gas purifying catalyst comprises a carrier containing aluminum borate represented by 9Al₂O₃ 2B₂O₃ and modified with La₂O₃ in an amount of 0.3 to 2 mass % on the basis of the mass of the aluminum borate, and Pd and Ba supported on the carrier.

2. The exhaust gas purifying catalyst product according to claim 1, wherein the amount of supported Pd on the carrier of the catalyst, as reduced to metallic Pd, is 0.3 to 3 mass % on the basis of the mass of the carrier.
